(19) United States
(12) Patent Application Publication
(10) Pub. No.: US 2003/0201754 A1
(43) Pub. Date: Oct. 30, 2003

(54) Method for operation an appliance and an appliance that uses the method

(76) Inventor: Wayne Ernest Conrad, Hampton (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/421,759

(22) Filed: Apr. 24, 2003

(30) Foreign Application Priority Data
Apr. 25, 2002 (CA) 2,383,445

(51) Int. Cl. H02J 7/00

(52) U.S. Cl. 320/116

(57) ABSTRACT

A method and apparatus is provided which uses a plurality of batteries that are sequentially used to power an appliance. While one or more batteries are used to power the appliance, one or more spar batteries are charged for subsequent use. The rate of charge of the batteries is comparable to the rate of discharge of the batteries by the appliance or faster. Thus the appliance may be essentially continuously used by the user removing the discharged battery and inserting a charged battery.

### FIELD OF THE INVENTION

This application relates to battery-powered appliances such as vacuum cleaners, power tools garden tools, and in one particular embodiment, to battery-powered vacuum cleaners.

### BACKGROUND OF THE INVENTION

Battery-powered appliances such as hand held drills, lawn mowers and vacuum cleaners are currently sold on the market. Battery-powered hand held drills typically operate for about 20 minutes on a fully charged battery pack and require about 8 hours to recharge. Thus, if the consumer uses a battery-powered drill substantially continuously, then the battery pack in the drill will be drained before a replacement battery pack is charged. Accordingly, battery-powered power drills are not designed for continuous operation. If a consumer wanted to be able to operate a power drill continuously, then the consumer would have to purchase multiple spare batter packs and associated chargers so that a fully charged battery pack would always be available.

Similarly, a battery-powered lawn mower will operate for about 40 to 60 minutes on a fully charged battery pack and require about 8 hours to recharge. Due to the capacity of the battery pack, a battery-powered lawn mower must typically be plugged into an electrical outlet for many hours before it can be used again. Thus, a battery-powered lawn mower is generally only useable for smaller lawns.

Battery-powered vacuum cleaners are typically designed for quick cleaning jobs. For example, they tend to be small machines, such as hand held vacuum cleaners, that are operated for a short period of time (e.g., 5 to 15 minutes) after which the hand held vacuum cleaner is placed in a cradle or plugged in for recharging. When placed in a cradle, the batteries are supplied with, e.g., a trickle charge. An advantage of the trickle charge is that, once charged, the batteries will remain fully charged as long as the vacuum cleaner is positioned in the cradle. Thus the vacuum cleaner is always ready for use. However, if the batteries of a hand held vacuum cleaner are fully discharged, then the batteries will require many hours to recharge (e.g. 8 hours, if the battery pack is recharged at ⅛C). Thus a hand held vacuum cleaner is generally only suitable for cleaning small areas. Consumers who purchase a hand held vacuum cleaner typically also own a full sized vacuum cleaner (e.g., an upright vacuum cleaner or a canister vacuum cleaner) A hand held vacuum cleaner is used for cleaning small areas or after a single spill. Full sized vacuum cleaners are used for general cleaning of a house or an apartment.

Full sized battery-powered vacuum cleaners have been designed. In a typical cleaning session, a vacuum cleaner will be operated about 80-90% of the time or more. The consumer will typically turn the vacuum cleaner off to move furniture, such as a table, so as to clean under the table or to dust an area or to answer the telephone. Therefore, battery-powered vacuum cleaners have been designed to have sufficient power in a single battery pack to operate for the full amount of the actual time that a vacuum cleaner would be used in a single cleaning session. Thus, the capacity of the battery pack that is required is relatively large and this increases the recharge time for the battery pack. If a cleaning session is one hour long and a battery pack having sufficient power to operate a full size vacuum cleaner for thirty minutes were utilized, then the battery pack would typically be recharged at 0.5C to 0.125C, to minimize the cost of the charging system. Such charging rates would recharge the battery pack in 2 to 8 hours. Such a product is undesirable, as a consumer would not want to wait 2 or more hours to finish vacuuming.

### SUMMARY OF THE INVENTION

In accordance with the instant invention, a battery-powered appliance system includes a first battery pack that is used to operate the appliance and a second battery pack that may be placed in a charger and charged while the first battery pack is used to continuously operate the appliance. Thus, in operation, the first battery pack may be used to continuously operate the appliance until the first battery pack is discharged. When the first battery pack is discharged to the point where it will not operate the appliance, the first battery pack may be removed from the appliance and placed in the charger. At the same time, the second battery pack may then be inserted into the appliance and used to operate the appliance. The first battery pack may then be recharged while the appliance is operated using the power available in the second battery pack. If continued use of the appliance is required when the second battery pack has been drained, then, the second battery pack may be removed from the appliance and placed in the charger. At the same time, the first battery pack, which has been recharged while the second battery pack was in use, may then be inserted into the appliance and used to operate the appliance.

The rate of discharge of the battery pack when used to operate the appliance and the rate of charging of the battery pack when inserted in the charger are selected so that the battery pack in the charger is ready for use by the time the battery pack in the appliance requires replacement. Using this method of operation, a battery-powered appliance may be operated essentially continuously. As used herein, an appliance is not considered to be running continuously if it is in a standby mode. The operation of an appliance is used to refer to the time that a consumer is actually using the appliance to perform a function, e.g., the time a vacuum cleaner is in use to clean carpet or the time a hedge trimmer is used to trim a hedge.

For example, the appliance may be a full sized vacuum cleaner such as an upright vacuum cleaner or a canister vacuum cleaner or a stick vacuum cleaner. The vacuum cleaner is provided with two battery packs. A first battery pack is used to power the vacuum cleaner while a consumer cleans their home. If the spare battery pack is discharged, then it is placed in the charger before the consumer starts to use the vacuum cleaner, e.g. just before the vacuum cleaner is turned on. When the battery pack in the vacuum cleaner is discharged, then the spare battery pack may be used to operate the vacuum cleaner. At this time, the first battery pack, which was discharged when the vacuum cleaner was used may be recharged. Since the spare battery pack will be recharged when the battery pack in the vacuum cleaner is discharged, each battery pack may be designed to run for only part of the time required for a cleaning session. For example, if a cleaning session is 40 minutes, then each battery pack may be designed to operate the vacuum cleaner for 20 minutes. At the end of 20 minutes, the discharged battery pack in the machine is replaced by the charged spare battery pack and the discharged battery pack may be placed in the charger for charging. Alternately, if a cleaning session is 30 minutes, then each battery pack may be designed to operate the vacuum cleaner for 15 minutes. At the end of 15 minutes, the discharged battery pack in the machine is replaced by the charged spare battery pack and the discharged battery pack may be placed in the charger for charging. After another 15 minutes, the battery packs may again be swapped. Accordingly, it is preferred that each battery pack has the same capacity.

It will be appreciated that the battery packs may have different capacities. For example, one battery pack may be adapted to be recharged at a faster rate then the other, e.g. by having an improved heat dissipation mechanism to prevent overheating while recharging at a faster rate than the other battery pack. Thus, the battery pack with the faster recharge time may have a higher capacity. In such a case, the appliance must be designed to operate using each battery pack and the charger must be adapted to charge each battery pack or different chargers must be provided.

One advantage of this approach is that the weight of each battery pack may be reduced. This can reduce the weight of a vacuum cleaner by 1-2 pounds. A further advantage is that the capacity of each battery pack is reduced, thus reducing the amount of heat that has to be dissipated during the charging process to avoid overheating and damaging the batteries.

In accordance with the instant invention, a vacuum cleaning system comprises a vacuum cleaner and two or more batteries or battery packs that may be used sequentially. The first battery pack would be used while the second was recharging (if the second battery pack was discharged) and the second battery pack would be used while the first was recharging. The system would be designed such that, during normal use, one of the battery packs would be discharged by powering the vacuum cleaner in about the same amount of time that the other battery pack is charged. Thus, when one battery pack is discharged, the other is ready for use and the consumer may then continue cleaning without waiting for a battery pack to recharge.

In another embodiment, the battery pack is preferably recharged at a rate of 2C and more preferably at a rate of 3C while the battery pack is preferably discharged at a rate of 2C or less.

In another embodiment, the battery pack is preferably recharged at a rate of 3C and more preferably at a rate of 4C while the battery pack is preferably discharged at a rate of 3C or less.

In another embodiment, the battery pack is preferably recharged at a rate of 5C and more preferably at a rate of 6C while the battery pack is preferably discharged at a rate of 5C or less.

In another embodiment, the battery pack is preferably recharged at a rate of 10C and more preferably at a rate of 12C while the battery pack is preferably discharged at a rate of 10C or less.

To this end, the vacuum cleaning system is designed such that the rate of power consumption by the vacuum cleaner is comparable to, and preferably less than, the rate at which the battery pack may be recharged. The rate of consumption may be slightly higher than the recharge rate since a consumer may turn the vacuum cleaner off intermittently to move furniture, answer the door or the telephone or the like. For example, for a particular battery charger design, the vacuum cleaner may be designed to limit the power drawn from the battery pack to the rate at which the selected charger can recharge the battery pack. Alternately, the charger could be designed to recharge a battery pack in about the same amount of time that a similar battery pack would be discharged by a selected vacuum cleaner. From the perspective of the consumer, a vacuum cleaner is viable as long as it may be used in a typical use pattern until the home is cleaned.

The battery charger is a separate off-board unit so that the battery charger may be used to recharge a battery pack while the appliance is operated by another battery pack. Thus the battery-powered appliance may be operated without a cord having to be plugged into an electrical outlet. It will be appreciated that a battery charger may be provided on-board the appliance, e.g., to keep the battery pack in the battery-powered appliance fully charged when the appliance is not in use.

The vacuum cleaner is preferably configured so as to allow a battery pack to be easily replaced (e.g. without the need of a screwdriver or the like to remove a cover plate)

It will be appreciated by those skilled in the art that a battery-powered appliance may use a single battery or a battery pack which includes a plurality of batteries (e.g. AA, sub C, C or D batteries). As used herein, the words “battery” and “battery pack” are used interchangeably to refer to the battery source for an appliance

Typically, battery-powered appliances use batteries that have a large capacity (e.g. up to 9 amp hours). Such batteries require a high current to recharge the batteries quickly. For example, a 9-amp hour battery would typically require a 10-amp hour charger to recharge the battery in about 1 hour. Such high currents will result in substantial heating of the battery. In accordance with another embodiment of the instant invention, the batteries preferably have a capacity less than 5 amp hours. Preferably, the capacity is from 1 to 5 amp hours, more preferably from 2 to 4 amp hours and most preferably from 2.5 to 3.5 amp hours. Thus, a larger number of batteries are required to obtain the same operating or run time for an appliance. However, the current required to charge the batteries in the same amount of time is reduced thus reducing the amount of heat that has to be dissipated to avoid damaging the batteries. Preferably, the batteries are batteries AA, sub C or C batteries, more preferably, sub C or C batteries and most preferably sub C batteries. However, in accordance with this invention, a plurality of D batteries with a capacity of about 3.5 or 4.5 amp hours could be utilized are also preferred. Generally, a sufficient amount of batteries are provided which deliver the required voltage to run the appliance. The capacity of the batteries is selected based on the desired run time

The method may be used with various appliances and preferably with appliances whose typically usage in a single session is about one hour or less. Examples of such appliances are vacuum cleaners, power tools, such as hand held drills, saws such as jig saws and skill saws, nailing guns and the like and garden tools such as lawn mowers, hedge trimmers, leaf blowers, edge trimmers, fertilizer spreaders and the like, more preferably vacuum cleaners and power tools and, most preferably, vacuum cleaners

By using the method of the instant invention, a wide range of battery-operated products that may be continuously operated may be designed. With the use of one spare battery pack, a product may be design that will operate for, e.g., about sixty minutes with a recharge time of about sixty minutes or for about thirty minutes with a recharge time of about thirty minutes or for about twenty minutes with a recharge time of about twenty minutes or for about fifteen minutes with a recharge time of about fifteen minutes.

In an alternate embodiment, the rate of charge is at least XC and the rate of discharge is XC where X is a number. Preferably, the rate of charge is at least about X+0.5C and the rate of discharge is XC where X is a number. X may be an integer or a fraction.

It will be appreciated that a battery pack may be only “essentially recharged” in the time that a battery pack is discharged by continuous use in an appliance. When a battery is charged at a rate of 1C or greater, the battery will not generate an amount of heat that would damage the battery until the battery has been charged to more than about 85-90% of its capacity. It will be appreciated that the percent of full capacity that a battery has reached when it is essentially charged will vary based on the charging characteristics of a particular battery.

Thus, in accordance with another embodiment of the instant invention, a battery pack for a battery-powered appliance could be essentially recharged (preferably charged to about 85-90% of capacity) at a high rate, e.g. a rate of 1C or greater. Thereafter, the charger may optionally switch to a slower charge rate, preferably a trickle charge. Once the charge rate is switched to a trickle charge, the battery pack could remain in the charger until it is needed without overheating. Preferably, this mode of operating is used with batteries, such as nickel metal hydride batteries, that do not have a memory (i.e. they do not lose capacity if not fully recharged each time they are recharged). The battery pack charger could be programmed to top up (i.e. fully charge) the battery pack (e.g. from 85% charge to fully charged) every, e.g., 20^{th} time a battery pack is placed in the charger for charging. Thus, the first 19 times a battery pack is placed in the charger, it is essentially charged. On the 20^{th} time a battery pack is placed in the charger, it is fully charged.

Alternately, a battery charger could have a manually operable button to permit a consumer to engage a full charge cycle when desired (e.g., the consumer has completed the use of the battery pack for the day). Alternately, the battery charger could automatically switch to a slower charging mode after the battery pack has been charged to, e.g., 85% capacity. Thus, if a consumer does not continuously use an appliance (e.g., they stop to talk on the telephone), the charger would continue charging the battery pack until the battery pack is removed from the charger. Once a battery pack is fully charged, the charger would stop the charging cycle. Alternately, the charger could continue to charge using a trickle charge so that the battery pack in the charger is always ready for use.

In accordance with this alternate embodiment, the system would be designed such that, during normal use, one of the battery packs would be discharged by powering the vacuum cleaner, in about the same amount of time that the other battery pack is charged to about 85-90% of capacity. When a consumer has completed use of the appliance, for example if a consumer has finished cleaning, they can leave a battery pack in the charger and allow the battery pack to be fully recharged.

Means for determining the charges state of a battery as a battery is charged are known in the art and any such sensor may be incorporated into a battery charger according to the instant invention

It will be appreciated that the charger may be adapted for holding and charging two battery packs. Thus, when a consumer finishes using the appliance, they could place the battery pack from the appliance into the battery charger along with the spare battery pack. Thus both battery packs could be fully charged when the appliance is next required.

It will also be appreciated that the same charger could be designed to charge battery packs that are designed for a number of different appliances. Further, a plurality of appliances could be designed to operate on the same battery pack. Thus a system could comprise a battery charger, a plurality of batteries and a plurality of appliances operable on the same battery pack.

In accordance with one aspect of the instant application, there is provided a system comprising,

(a) a battery-powered appliance adapted for removably receiving a battery pack, the appliance adapted to discharge a battery pack received therein at a particular rate of discharge;

(b) a battery charger adapted to recharge at least one battery pack at a particular rate of charge; and,

(c) first and second battery packs

wherein the rate of charge of a battery pack in the battery charger is about the same or greater than the rate of discharge of a battery pack by the appliance.

In one embodiment, the rate of charge and the rate of discharge are essentially the same.

In another embodiment, the rate of charge is at least as fast as the rate of discharge.

In another embodiment, the rate of charge is at least XC and the rate of discharge is XC where X is a number.

In another embodiment, the rate of charge is at least about X+0.5C and the rate of discharge is XC where X is a number

In another embodiment, the appliance is a vacuum cleaner.

In another embodiment, the appliance is powered by a single battery stick.

In another embodiment, each battery has a rating of up to 5 amp hours.

In another embodiment, each battery has a rating of from 2 to 4 amp hours.

In another embodiment, the batteries are selected from AA, sub C and C format batteries.

In another embodiment, the batteries are selected from sub C and C format batteries.

In another embodiment, the rate of charge is greater than 1C and is selected to charge the first battery pack up to a temperature proximate the temperature at which batteries in the first battery pack will degrade by the time that the second battery pack will be discharged if used to continuously operate the battery-powered appliance.

In another embodiment, the rate of charge is greater than 1C and is selected to charge the first battery pack up to at least about 85% of its capacity by the time that the second battery pack will be discharged if used to continuously operate the battery-powered appliance

In accordance with another aspect of the instant invention, there is provided a method comprising

(a) providing a battery-powered appliance adapted for removably receiving at least one battery, a battery charger adapted to recharge at least one battery at a particular rate of charge, and at least first and second battery packs;

(b) operating the appliance with at least the first battery pack wherein the at least first battery pack is discharged at a rate particular rate of discharge: and,

(c) charging the second battery pack at the rate of charge wherein the rate of charge is about the same as or faster than the rate of discharge

In one embodiment, the rate of charge and the rate of discharge are essentially the same.

In another embodiment, the rate of charge is at least as fast as the rate of discharge.

In another embodiment, the rate of charge is at least XC and the rate of discharge is XC where X is a number.

In another embodiment, the rate of charge is at least about X+0.5C and the rate of discharge is XC where X is a number

In another embodiment, the method further comprises providing a battery-powered appliance that is adapted to be powered by a single battery stick.

In another embodiment, the method further comprises selecting batteries that each have a rating of up to 5 amp hours for the battery packs

In another embodiment, the method further comprises selecting batteries that each have a rating of from 2 to 4 amp hours for the battery packs.

In another embodiment, the method further comprises selecting batteries for the battery packs from AA, sub C and C format batteries.

In another embodiment, the method further comprises selecting batteries for the battery packs from sub C and C format batteries.

In another embodiment, the method further comprises comprising charging the battery pack at a rate of at least 1C until batteries in the battery pack approach a temperature at which the batteries will degrade.

In another embodiment, the method further comprises charging the second battery pack at a rate that is greater than 1C and is selected to charge the second battery pack up to a temperate proximate the temperature at which batteries in the second battery pack will degrade by the time that the first battery pack will be discharged if used to continuously operate the battery-powered appliance

In another embodiment, the method further comprises charging the second battery pack at a rate that is greater than 1C and is selected to charge the at least the first battery pack up to at least about 85% of its capacity by the time that the second battery pack will be discharged if used to continuously operate the battery-powered appliance

In another embodiment, the method further comprises charging the second battery pack up to full capacity at a rate to avoid degradation of the batteries in the second battery pack if the second battery pack is left in the battery charger once it has been charged to at least about 85% of its capacity.

In accordance with another embodiment of the instant invention, there is provided a system comprising:

(a) a plurality of different appliances, each appliance adapted to discharge a battery pack received therein at a particular rate of discharge;

(b) a plurality of battery packs, wherein each appliance is operable using one or more of the battery packs; and,

(c) charging means to simultaneously charge a plurality of battery packs, the charging means having a rate of charging a battery pack

wherein the rate of charge of a battery pack in the battery charger is about the same or greater than the fastest rate of discharge of a battery pack by an appliance.

In one embodiment, the charging means comprises a plurality of battery chargers.

In another embodiment, the charging means comprises a battery charger which is adapted to simultaneously charge a plurality of battery packs.

In another embodiment, the system comprises a battery pack for each of the appliances and at least one additional spare battery pack

In another embodiment, the rates of discharge are about the same.

In another embodiment, the rates of discharge are the same.

### BRIEF DESCRIPTION OF THE DRAWINGS

For a better understanding of the present invention and to show more clearly how it may be carried into effect, reference will now be made by way of example to the accompanying drawings, of the preferred embodiments of the present invention, in which;

FIG. 1 is a perspective view of a vacuum cleaning system according to the instant invention,

FIG. 2 is a cross sectional view of a battery pack, along the longitudinal axis of the battery pack, that may be used in a system according to the instant invention such as the vacuum cleaning system of FIG. 1;

FIG. 3 is a perspective view of an alternate battery pack that may be used in a system according to the instant invention such as the vacuum cleaning system of FIG. 1; and,

FIGS. 4 and 5 are schematic drawings exemplifying the method according to the instant invention

### DETAILED DESCRIPTION OF THE INVENTION

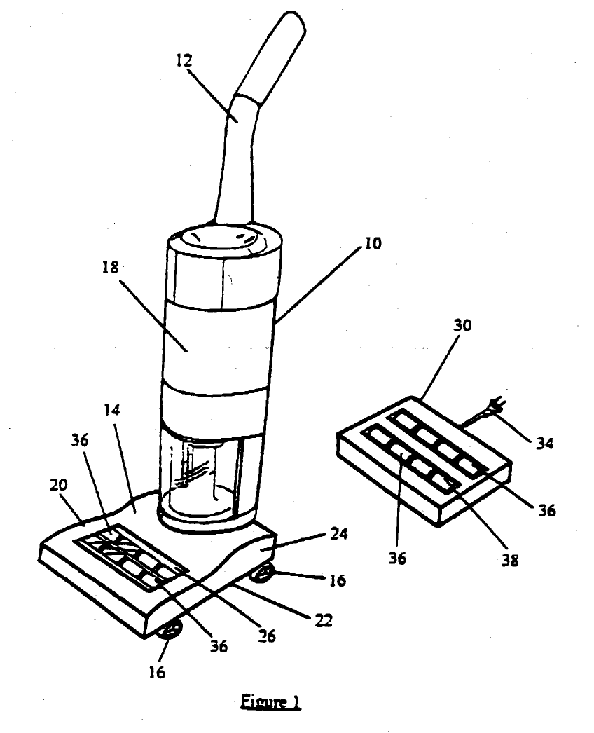

In accordance with the instant invention, a system includes an appliance and a separate battery charger. Referring to FIG. 1, the system is exemplified as it may be applied to an upright vacuum cleaner 10.

Upright vacuum cleaner 10 may be of any design known in the art. Accordingly, upright vacuum cleaner 10 may have a handle 12, cleaner head 14, means for movably supporting cleaner head 14 on the floor (e.g., wheels 16, glides or an other member known in the vacuum cleaner art), and a main or upper casing 18 Cleaner head 14 and casing 18 house a dirty air inlet adjacent the floor to be cleaned, a dust separation mechanism and motor of any type known in the art for use in vacuum cleaning devices.

Cleaner head 14 may be of any design known in the art. Cleaner head 14 has an upper surface 20, a lower surface 22 and transversely spaced apart, opposed sides 24. Cover panel 26 is provided, e.g., on upper surface 20 of cleaner head 14 to allow one or more batteries 38 to be removably positioned therein. In the embodiment of FIG. 1, cover 26 is shown as transparent so as to enable two battery sticks 36 that are positioned in cleaner head 14 to be visible.

A separate charger 30 for receiving and charging the battery sticks 36 is also shown in FIG. 1. Charger 30 may use any power source to recharge battery sticks 36. For example, charger 30 may include an electrical cord 34 which may be plugged into a standard electrical outlet in a house or into a generator (e.g., in the case of a mobile home).

Cover panel 26 is removable received on cleaning head 14 so as to cover the compartment (not shown) in which battery sticks 36 are positioned. It will be appreciated that cover panel 26 is optional. Further, it will also be appreciated that a compartment for receiving battery sticks 36 may be positioned at any other desired location on the vacuum cleaner 10 and the invention claimed herein is not limited by the specific configuration shown in FIG. 1.

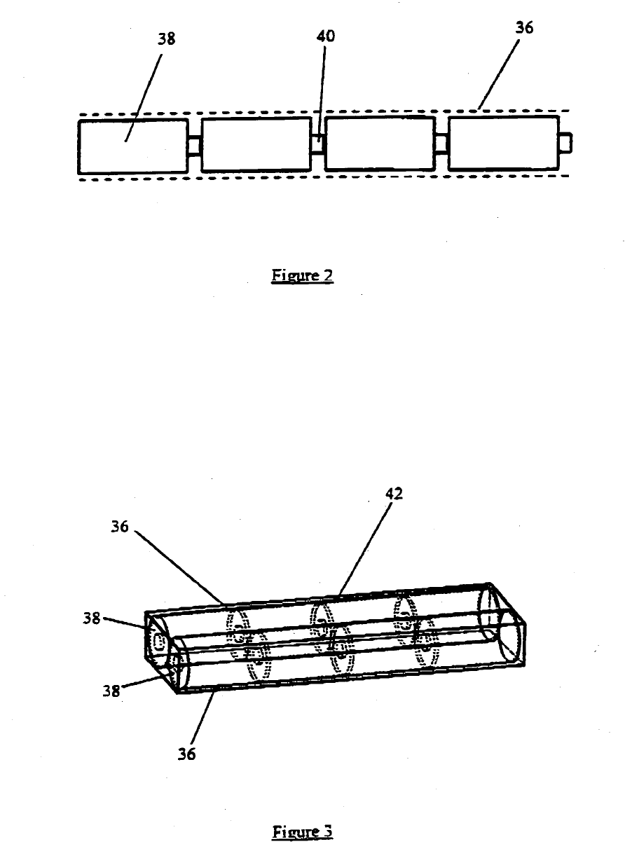

As shown in FIG. 2, a battery stick 36 comprises a plurality of batteries 38 Batteries 38 may be permanently connected together such as by spot welds 40 as is known in the art. It will be appreciated that the method and system of the instant invention may be utilized with any number or configuration of batteries 38. For example, the batteries 38 could be individually removable from vacuum cleaner 10 However, it is preferred that batteries 38 are packaged as a battery stick 36. More preferably, as shown in FIG. 3, batteries 38 or battery sticks 36 are mounted in a non-conductive (e.g. plastic) external hard shell or battery cover 42 so as to form a battery pack 32. Thus all of the batteries 38 may be removed from appliance 10 in a single step.

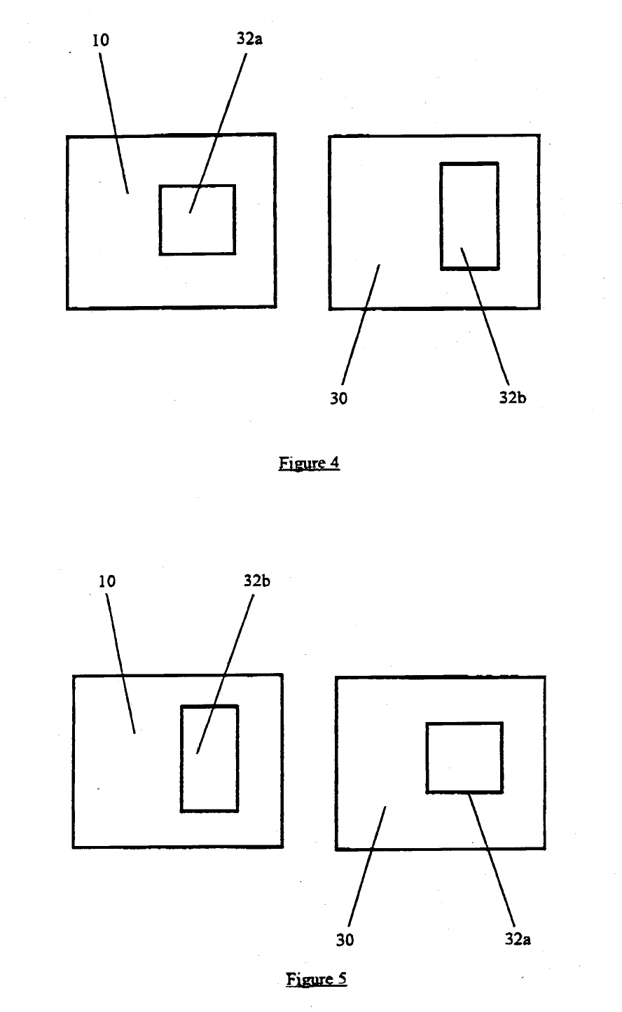

The system according to the instant invention includes at least one appliance 10 and at least one battery charger 30. It will be appreciated that appliance 10 may require two or more battery packs 32 to operate. In such a case, two or more battery chargers 30 may be provided and/or battery charger 30 may be adapted to simultaneously charge a plurality of battery packs 32. For simplicity, the system exemplified in FIG. 4 uses a single appliance that is powered by a single battery pack 32.

As shown in FIG. 4, appliance 10 has battery pack 32a installed therein. Battery pack 32a is charged so that it may power appliance 10. At the beginning of use of the system, battery pack 32b may already be charged. In such a case, battery pack 32b does not require charging. If battery pack 32b requires recharging, it is placed in charger 30 and charged while battery pack 32a powers appliance 10. When battery pack 32a is discharged, then battery pack 32a may be placed in charger 30 and battery pack 32b may be installed in appliance 10 for use in powering appliance 10 (see FIG. 5) If further use of appliance 10 is required after battery pack 32b is discharged, then the positions of battery packs 32a and 32b may be reversed (i.e., returned to the configuration shown in FIG. 4) so that battery pack 32a is again used to power appliance 10 and battery pack 32b is charged

Battery pack 32 may have a relatively low in use life. For example, it may have an in use life sufficient for continuously or at least essentially continuously operating appliance 10 for about 10 to 30 minutes, preferably, 10 to 20 minutes and more preferably about 15 minutes. Such an in use life has heretofore not been acceptable in a battery-powered appliance which is typically used for longer periods of time during a single use. However, by selecting the charge and discharge rates to be essentially the same, or the charge rate to be higher than the discharge rate, an improved battery-powered appliance is obtained

The use of such low in use life is advantageous. One advantage of the instant invention is that fewer batteries may be incorporated into an appliance and/or the appliance may utilize batteries having a lower amp hour rating, thus reducing the cost of the appliance even when the cost of the charger and the second battery pack is included A further advantage is that the weight of the appliance is reduced. This can improve the mobility of a vacuum cleaner, especially on carpet

When a battery stick is charged, the temperature of the stick, as well as the voltage and/or current is typically monitored. Preferably, charger 30 monitors the condition of batteries 38 or battery stick 36 as the batteries are recharged. Thus, a further advantage of the instant invention is that by designing an appliance to operate on fewer battery sticks (e.g. only a single stick as opposed to two or three), the complexity and cost of the charger may be reduced since the charger needs to only monitor fewer battery sticks or fewer batteries (e.g., one stick as opposed to a plurality of sticks). If a plurality of sticks are recharged simultaneously by the same charger, then the charger must monitor each of these parameters for each stick, thus increasing the complexity and cost of the charger.

To obtain longer run times, a plurality of battery sticks may be employed. For example, to obtain a use life or run time of sixty minutes of continuous operation of, e.g. a vacuum cleaner, three sticks with a capacity of twenty minutes each might be required. The reason a single battery stick with a capacity to operate the vacuum cleaner for sixty minutes is not desirable is that the number of batteries that may be included in a single stick is limited by the geometry of the appliance as well as the charging dynamics of the batteries themselves. Battery sticks are typically designed as a single cylindrical tube containing a linear row of batteries (see FIG. 2). If a stick were to include more batteries, then the size of the appliance would have to be increased so that it could receive the stick. Further, batteries charge non-uniformly and this also limits the number of batteries in a single stick. The number of NiCad or nickel metal hydride batteries in a single stick is preferably 7 or fewer, more preferably 6 or fewer and most preferably 5 or fewer batteries. In accordance with one embodiment of the instant invention, an appliance is preferably designed to operate on a single battery stick.

In accordance with another embodiment of the instant invention, an appliance may be operated by a plurality of battery sticks (e.g. the battery pack of FIG. 3). In such a case, the number of batteries in each stick may be reduced since shorter in use times for each battery pack 32 is acceptable.

A further advantage of the instant invention is that faster recharge rates may be obtained without using more complex or expensive technology. For example, a charger that has the capacity to charge three battery sticks in one hour can charge a single battery stick in about twenty minutes. Thus, by using the same charger components, a battery pack for a vacuum cleaner that can operate the vacuum cleaner for only twenty minutes (e.g. a single battery stick) can be recharged at three times the rate as a battery pack that would operate the vacuum cleaner for one hour (e.g. three battery sticks). Thus by providing at least two battery sticks and a battery recharger, a vacuum cleaner that can run continuously except for the time required to replace the battery pack can be produced. The resultant vacuum cleaner has fewer on board batteries and is therefore lighter and more maneuverable.

While the above description constitutes the preferred embodiments, it will be appreciated that the present invention is susceptible to modification and change without departing from the fair meaning of the accompanying claims.

1) A system comprising:
a) a battery-powered appliance adapted for removably receiving a battery pack, the appliance adapted to discharge a battery pack received therein at a particular rate of discharge;
b) a battery charger adapted to recharge at least one battery pack at a particular rate of charge; and,
c) first and second battery packs
wherein the rate of charge of a battery pack in the battery charger is about the same or greater than the rate of discharge of a battery pack by the appliance.

2) The system as claimed in claim 1 wherein the rate of charge and the rate of discharge are essentially the same.

3) The system as claimed in claim 1 wherein the rate of charge is at least as fast as the rate of discharge.

4) The system as claimed in claim 1 wherein the rate of charge is at least XC and the rate of discharge is XC where X is a number.

5) The system as claimed in claim 1 wherein the rate of charge is at least about X+0.5C and the rate of discharge is XC where X is a number.

6) The system as claimed in claim 1 wherein the appliance is a vacuum cleaner.

7) The system as claimed in claim 1 wherein the appliance is a power tool.

8) The system as claimed in claim 1 wherein the appliance is a garden tool.

9) The system as claimed in claim 1 wherein the appliance is powered by a single battery stick.

10) The system as claimed in claim 1 wherein each battery has a rating of up to 5 amp hours.

11) The system as claimed in claim 1 wherein each battery has a rating of from 2 to 4 amp hours.

12) The system as claimed in claim 1 wherein the batteries are selected from AA, sub C and C format batteries.

13) The system as claimed in claim 1 wherein the batteries are selected from sub C and C format batteries.

14) The system as claimed in claim 1 wherein the rate of charge is greater than 1C and is selected to charge the first battery pack up to a temperature proximate the temperature at which batteries in the first battery pack will degrade by the time that the second battery pack will be discharged if used to continuously operate the battery-powered appliance.

15) The system as claimed in claim 1 wherein the rate of charge is greater than 1C and is selected to charge the first battery pack up to at least about 85% of its capacity by the time that the second battery pack will be discharged if used to continuously operate the battery-powered appliance.

16) A method comprising:
a) providing a battery-powered appliance adapted for removably receiving at least one battery, a battery charger adapted to recharge at least one battery at a particular rate of charge, and at least first and second battery packs,
b) operating the appliance with at least the first battery pack wherein the at least first battery pack is discharged at a rate particular rate of discharge;
c) charging the second battery pack at the rate of charge wherein the rate of charge is about the same as or faster than the rate of discharge.

17) The method as claimed in claim 16 wherein the rate of charge and the rate of discharge are essentially the same.

18) The method as claimed in claim 16 wherein the rate of charge is at least as fast as the rate of discharge.

19) The method as claimed in claim 16 wherein the rate of charge is at least XC and the rate of discharge is XC where X is a number.

20) The method as claimed in claim 16 wherein the rate of charge is at least about X+0.5C and the rate of discharge is XC where X is a number.

21) The method as claimed in claim 16 comprising providing a battery-powered appliance that is adapted to be powered by a single battery stick.

22) The method as claimed in claim 16 further comprising selecting batteries that each have a rating of up to 5 amp hours for the battery packs.

23) The method as claimed in claim 16 further comprising selecting batteries that each have a rating of from 2 to 4 amp hours for the battery packs.

24) The method as claimed in claim 16 further comprising selecting batteries for the battery packs from AA, sub C and C format batteries.

25) The method as claimed in claim 16 further comprising selecting batteries for the battery packs from sub C and C format batteries.

26) The method as claimed in claim 16 further comprising charging the battery pack at a rate of at least 1C until batteries in the battery pack approach a temperature at which the batteries will degrade.

27) The method as claimed in claim 16 further comprising charging the second battery pack at a rate that is greater than 1C and is selected to charge the second battery pack up to a temperate proximate the temperature at which batteries in the second battery pack will degrade by the time that the first battery pack will be discharged if used to continuously operate the battery-powered appliance.

28) The method as claimed in claim 16 further comprising charging the second battery pack at a rate that is greater than 1C and is selected to charge the at least the first battery pack up to at least about 85% of its capacity by the time that the second battery pack will be discharged if used to continuously operate the battery-powered appliance.

29) The method as claimed in claim 28 further comprising charging the second battery pack up to full capacity at a rate to avoid degradation of the batteries in the second battery pack if the second battery pack is left in the battery charger once it has been charged to at least about 85% of its capacity.

30) A system comprising:
a) a plurality of different appliances, each appliance adapted to discharge a battery pack received therein at a particular rate of discharge;
b) a plurality of battery packs, wherein each appliance is operable using one or more of the battery packs; and,
c) charging means to simultaneously charge a plurality of battery packs, the charging means having a rate of charging a battery pack
wherein the rate of charge of a battery pack in the battery charger is about the same or greater than the fastest rate of discharge of a battery pack by an appliance.

31) The system as claimed in claim 30 wherein the charging means comprises a plurality of battery chargers.

32) The system as claimed in claim 30 wherein the charging means comprises a battery charger which is adapted to simultaneously charge a plurality of battery packs.

33) The system as claimed in claim 30 comprising a battery pack for each of the appliances and at least one additional spare battery pack.

34) The system as claimed in claim 30 wherein the rates of discharge are about the same.

35) The system as claimed in claim 30 wherein the rates of discharge are the same.
